(19) United States
(12) Patent Application Publication
(10) Pub. No.: US 2020/0079282 A1
(43) Pub. Date: Mar. 12, 2020

(54) PARKING CONTROL DEVICE, PARKING CONTROL METHOD, VEHICLE, AND COMPUTER READABLE NON-TRANSITORY RECORDING MEDIUM STORING A PROGRAM

(71) Applicant: HONDA MOTOR CO., LTD., TOKYO (JP)

(72) Inventors: Miki TSUJINO, WAKO-SHI (JP); Masashi YOSHIFUKU, WAKO-SHI (JP)

(21) Appl. No.: 16/561,458

(22) Filed: Sep. 5, 2019

(30) Foreign Application Priority Data
Sep. 7, 2018 (JP) 2018-167451

(51) Int. Cl. B60Q 1/48; B60W 30/06; B62D 15/02

(52) U.S. Cl. CPC B60Q 1/488; B60W 2050/0075; B62D 15/0285; B60W 30/06

(57) ABSTRACT

A parking control device includes a detection unit that detects at least one possible parking position in which a vehicle is capable of being parked, and a control unit that automatically operates a predetermined lighting device which can be viewed from the exterior of the vehicle, after a target parking position has been selected from among the possible parking positions, and initiates movement of the vehicle into the target parking position on the condition that the predetermined lighting device is operating.

### CROSS-REFERENCE TO RELATED APPLICATION

This application is based upon and claims the benefit of priority from Japanese Patent Application No. 2018-167451 filed on Sep. 7, 2018, the contents of which are incorporated herein by reference.

### BACKGROUND OF THE INVENTION

### Field of the Invention

The present invention relates to a parking control device, a parking control method, a vehicle, and a computer readable non-transitory recording medium in which a program is stored.

### Description of the Related Art

Recently, control systems have been proposed that are capable of controlling the timing of turning on and turning off the lighting of hazard lamps. In Japanese Laid-Open Patent Publication No. 2013-116698, a control system is disclosed which turns on the hazard lamps of a host vehicle when a parked vehicle is detected by an ultrasonic sensor installed in the host vehicle.

### SUMMARY OF THE INVENTION

However, in the control system disclosed in Japanese Laid-Open Patent Publication No. 2013-116698, a situation may occur in which the timing at which the hazard lamps are turned on happens too early. Further, with the control system described in Japanese Laid-Open Patent Publication No. 2013-116698, a situation may occur in which parking cannot be carried out in spite of the fact that the hazard lamps have been turned on.

An object of the present invention is to provide a parking control device, a parking control method, a vehicle, and a computer readable non-transitory recording medium storing a program, in which it is possible to carry out parking by appropriately operating a predetermined lighting device.

A parking control device according to one aspect of the present invention comprises a detection unit configured to detect at least one possible parking position in which a vehicle is capable of being parked, and a control unit configured to automatically operate a predetermined lighting device configured to be viewed from an exterior of the vehicle, after a target parking position has been selected from among the possible parking positions, and initiate movement of the vehicle into the target parking position on condition that the predetermined lighting device is operating.

A vehicle according to another aspect of the present invention comprises the above-described parking control device.

A parking control method according to yet another aspect of the present invention comprises a step of detecting at least one possible parking position in which a vehicle is capable of being parked, and a step of automatically operating a predetermined lighting device configured to be viewed from an exterior of the vehicle, after a target parking position has been selected from among the possible parking positions, and initiating movement of the vehicle into the target parking position on condition that the predetermined lighting device is operating.

According to yet another aspect of the present invention, there is provided a computer readable non-transitory recording medium in which a program is stored for executing in a computer a step of detecting at least one possible parking position in which a vehicle is capable of being parked, and a step of automatically operating a predetermined lighting device configured to be viewed from an exterior of the vehicle, after a target parking position has been selected from among the possible parking positions, and initiating movement of the vehicle into the target parking position on condition that the predetermined lighting device is operating.

According to the present invention, there can be provided the parking control device, the parking control method, the vehicle, and the computer readable non-transitory recording medium storing a program, in which it is possible to carry out parking by appropriately operating a predetermined lighting device.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a block diagram showing a vehicle equipped with a parking control device according to an embodiment of the present invention;

FIG. 2 is a diagram showing an example of an operation input unit;

FIG. 3 is a diagram conceptually illustrating an example of a portion of an image displayed on a display screen;

FIG. 4 is a flowchart showing operations of the parking control device according to the embodiment;

FIG. 5 is a flowchart showing operations of the parking control device according to a first modification of the embodiment;

FIG. 6 is a diagram showing an example of a communication terminal used in a second modification of the embodiment;

FIG. 7 is a block diagram showing an example of the communication terminal used in the second modification of the embodiment; and

FIG. 8 is a flowchart showing operations of the parking control device according to the second modification of the embodiment.

### DESCRIPTION OF THE PREFERRED EMBODIMENTS

Preferred embodiments of a parking control device, a parking control method, a vehicle, and a computer readable non-transitory recording medium in which a program is stored according to the present invention will be presented and described in detail below with reference to the accompanying drawings.

### Embodiment

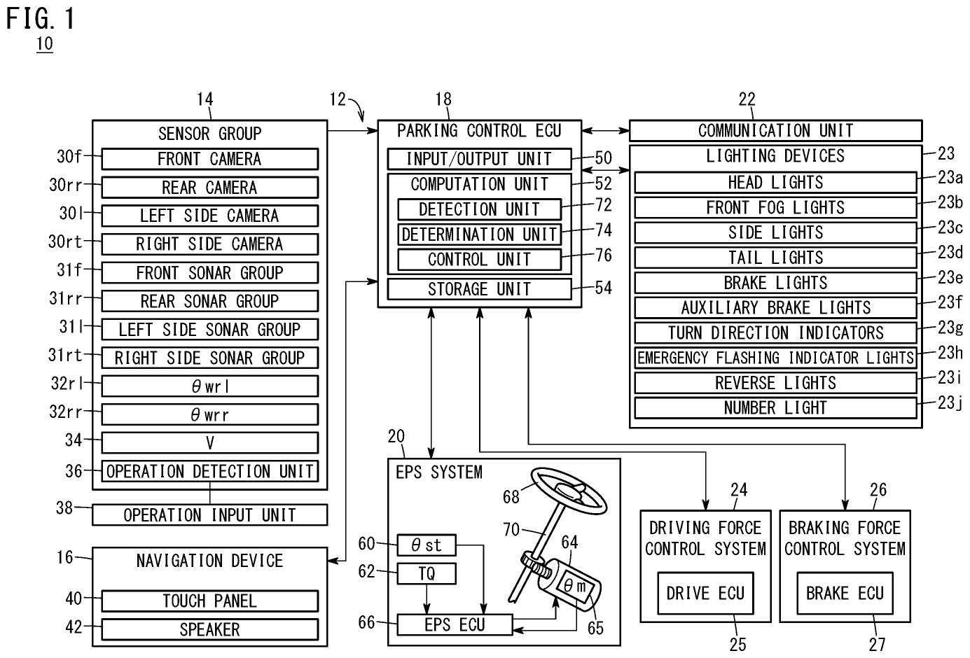

A parking control device, a parking control method, a vehicle, and a computer readable non-transitory recording medium in which a program is stored according to an embodiment of the present invention will be described below with reference to the drawings. FIG. 1 is a block diagram showing a vehicle equipped with a parking control device according to the embodiment.

A parking control device 12 according to the present embodiment controls parking of a vehicle 10 by performing automated steering. More specifically, operations of a steering wheel 68 are performed automatically by the parking control device 12. In this instance, although a case will be described as an example in which operations of an accelerator pedal (not shown), a brake pedal (not shown), and an operation input unit 38 are performed by a user, the invention is not necessarily limited to this example. For example, driving, braking, and steering may also be performed automatically.

As shown in FIG. 1, the parking control device 12 includes a sensor group 14, a navigation device 16, a parking control ECU (parking control electronic control device) 18, an EPS system (electric power steering system) 20, and a communication unit 22. The parking control device 12 further includes lighting devices 23, a driving force control system 24, and a braking force control system 26.

The sensor group 14 acquires various detection values used in connection with the parking control. The sensor group 14 includes a front camera 30f, a rear camera 30rr, a left side camera 301, and a right side camera 30rt. The sensor group 14 further includes a front sonar group 31f, a rear sonar group 31rr, a left side sonar group 311, and a right side sonar group 31rt. The sensor group 14 also includes vehicle wheel sensors 32r1 and 32rr, a vehicle speed sensor 34, and an operation detection unit 36.

The front camera 30f, the rear camera 30rr, the left side camera 301, and the right side camera 30rt output peripheral images obtained by capturing images of the surrounding periphery around the vehicle 10. The peripheral image captured by the front camera 30f is referred to as a front image. The peripheral image captured by the rear camera 30rr is referred to as a rear image. The peripheral image captured by the left side camera 301 is referred to as a left side image. The peripheral image captured by the right side camera 30rt is referred to as a right side image. A sideways image is constituted by the left side image and the right side image.

The front sonar group 31f, the rear sonar group 31rr, the left side sonar group 311, and the right side sonar group 31rt emit sound waves around the periphery of the vehicle 10, together with receiving reflected sounds from other objects. The front sonar group 31f includes, for example, four sonar devices. The sonar devices constituting the front sonar group 31f are respectively provided on a diagonally left forward side, a front left side, a front right side, and a diagonally right forward side of the vehicle 10. The rear sonar group 31rr includes, for example, four sonar devices. The sonar devices constituting the rear sonar group 31rr are respectively provided on a diagonally left rearward side, a rear left side, a rear right side, and a diagonally right rearward side of the vehicle 10. The left side sonar group 311 includes, for example, two sonar devices. The sonar devices constituting the left side sonar group 311 are respectively provided on a left forward side and a left rearward side of the vehicle 10. The right side sonar group 31rt includes, for example, two sonar devices. The sonar devices constituting the right side sonar group 31rt are respectively provided on a right forward side and a right rearward side of the vehicle 10.

The vehicle wheel sensors 32r1 and 32rr respectively detect the angles of rotation of the vehicle wheels (not shown). The vehicle wheel sensors 32r1 and 32rr may be configured by angle sensors, or alternatively, may be configured by displacement sensors. The vehicle wheel sensors 32r1 and 32rr output detection pulses each time that the vehicle wheels are rotated by a predetermined angle. The detection pulses output from the vehicle wheel sensors 32r1 and 32rr can be used to calculate the angles of rotation of the vehicle wheels and the rotational speeds of the vehicle wheels. The distance that the vehicle 10 moves can be calculated based on the angles of rotation of the vehicle wheels. The vehicle wheel sensor 32r1 detects, for example, the angle of rotation of the left rear wheel, or stated otherwise, an angle of rotation θwrl. The vehicle wheel sensor 32rr detects, for example, the angle of rotation of the right rear wheel, or stated otherwise, an angle of rotation θwrr.

The vehicle speed sensor 34 detects the speed of the vehicle body (not shown) of the vehicle 10, or stated otherwise, a vehicle speed V, and outputs the detected vehicle speed V to the parking control ECU 18. The vehicle speed sensor 34 detects the vehicle speed V on the basis of, for example, the rotation of a transmission counter shaft.

The operation detection unit 36 detects the content of operations performed by the user using the operation input unit 38, and outputs the detected operation content to the parking control ECU 18. More specifically, the operation detection unit 36 detects whether the operation input unit 38 is set to an ON state or an OFF state, and outputs the detection result to the parking control ECU 18.

The lighting devices 23 include, for example, head lights (head lamps) 23a, front fog lights (fog lamps) 23b, side lights (small lamps) 23c, tail lights (tail lamps) 23d, and brake lights (brake lamps) 23e. The lighting devices 23 further include, for example, auxiliary brake lights (high-mount stop lamps) 23f, turn direction indicators (winkers) 23g, and emergency flashing indicator lights (hazard lamps) 23h. The lighting devices 23 further include, for example, reverse lights (back lamps) 23i, and a number light (number plate lamp) 23j. The vehicle 10 is equipped with a plurality of such lighting devices which can be viewed from the exterior.

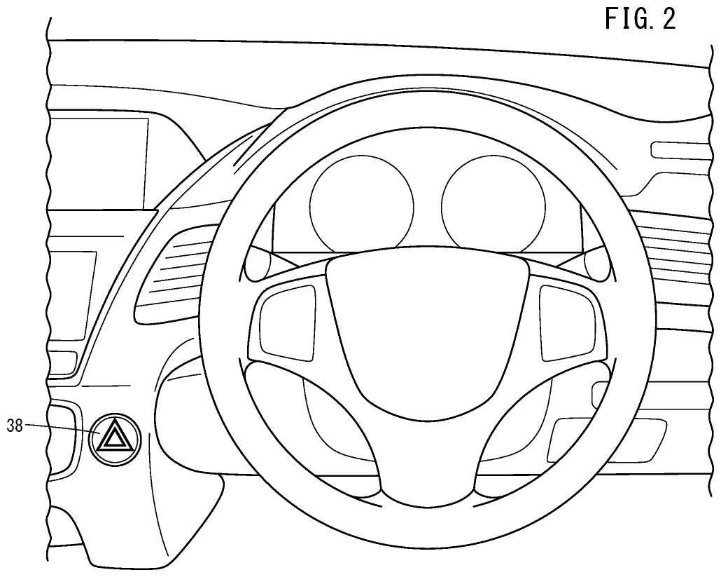

The operation input unit 38, for example, is an emergency flashing indicator light switch (hazard switch, hazard button) which is a switch for operating the emergency flashing indicator lights 23h. FIG. 2 is a diagram showing an example of the operation input unit. When the operation input unit 38, and more specifically, the emergency flashing indicator light switch is pressed by the user, the operation input unit 38 is turned on, and when the emergency flashing indicator light switch (the operation input unit 38) is returned again by the user to its original state, the operation input unit 38 is turned off.

The navigation device 16 detects the current position of the vehicle 10 using, for example, a GPS (Global Positioning System), and guides the user along a route to the destination. The navigation device 16 includes a non-illustrated storage device equipped with a map information database.

A touch panel 40 and a speaker 42 are provided in the navigation device 16. The touch panel 40 is capable of functioning as an input device as well as a display device of the parking control device 12. The user can input commands in relation to the parking control via the touch panel 40. In addition, a screen regarding the parking control can be displayed on the touch panel 40. Moreover, constituent elements other than the touch panel 40 may be used as the input device or the display device. Further, when the parking control takes place, voice guidance can be performed via the speaker 42. The speaker 42 can function as a notification unit which, prior to initiating movement of the vehicle 10 to a later-described target parking position 84, issues a notification to a passenger that movement of the vehicle 10 is going to be initiated.

The parking control ECU 18 includes an input/output unit 50, a computation unit 52, and a storage unit 54. The computation unit 52 can be configured, for example, by a CPU (Central Processing Unit). The computation unit 52 executes the parking control by controlling each of the respective units based on programs stored in the storage unit 54.

The computation unit 52 is equipped with a detection unit 72, a determination unit 74, and a control unit 76. The detection unit 72, the determination unit 74, and the control unit 76 can be realized by programs, which are stored in the storage unit 54, being executed by the computation unit 52.

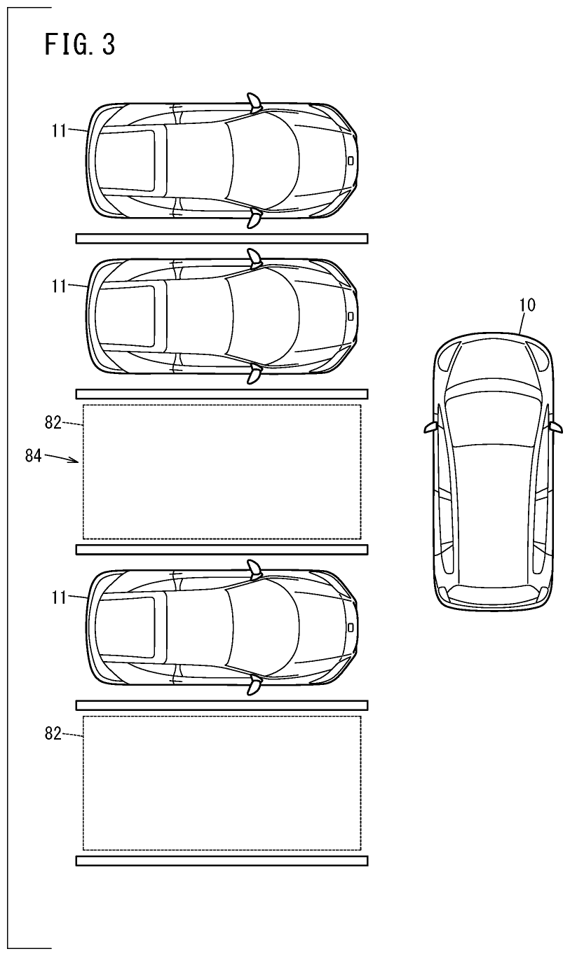

The detection unit 72 detects, on the basis of images and the like acquired by the cameras 30f, 30rr, 301, and 30rt, etc., at least one possible parking position 82 in which the vehicle 10 is capable of being parked. The possible parking positions 82 detected by the detection unit 72 can be displayed on the display screen of the touch panel 40 of the navigation device 16, for example. FIG. 3 is a diagram conceptually illustrating an example of a portion of an image displayed on the display screen. As shown in FIG. 3, an overhead view image including the vehicle (driver's own vehicle) 10 can be displayed on the display screen of the touch panel 40. As shown in FIG. 3, for example, other vehicles 11 are parked in three parking spaces from among five total parking spaces. Other vehicles 11 are not parked in two of the parking spaces from among the five total parking spaces. The detection unit 72 can detect, as possible parking positions 82, the parking spaces in which other vehicles 11 are not parked. Moreover, such an overhead view image can be generated, for example, by appropriately using the above-described sensor group 14. The target parking position 84 can be selected by the user from among the possible parking positions 82 displayed on the touch panel 40. For example, the target parking position 84 can be selected by the user touching any one of the possible parking positions 82 displayed on the touch panel 40. Moreover, although an exemplary case has been described herein in which the target parking position 84 is selected by the user, the present invention is not limited to this feature. The target parking position 84 may be automatically selected by the control unit 76.

The determination unit 74 determines whether or not the emergency flashing indicator lights (predetermined lighting devices) 23h are operating.

The control unit 76 administers an overall control of the parking control device 12 according to the present embodiment, together with carrying out a predetermined control. After the target parking position 84 has been selected from among the possible parking positions 82, the control unit 76 initiates movement of the vehicle 10 into the target parking position 84 on the condition that the lighting devices 23 are operating.

The EPS system 20 includes a steering angle sensor 60, a torque sensor 62, an EPS motor 64, a resolver 65, and an EPS ECU (EPS electronic control unit) 66.

The steering angle sensor 60 detects a steering angle θst of the steering wheel 68. The torque sensor 62 detects a torque TQ applied to the steering wheel 68.

The EPS motor 64 applies a driving force or a reaction force to a steering column 70 connected to the steering wheel 68, thereby enabling assistance of operations of the steering wheel 68 by the driver, and automated steering at the time of the parking control. The resolver 65 detects an angle of rotation θm of the EPS motor 64.

The EPS ECU 66 administers an overall control of the EPS system 20. The EPS ECU 66 is equipped with an input/output unit (not shown), a computation unit (not shown), and a storage unit (not shown).

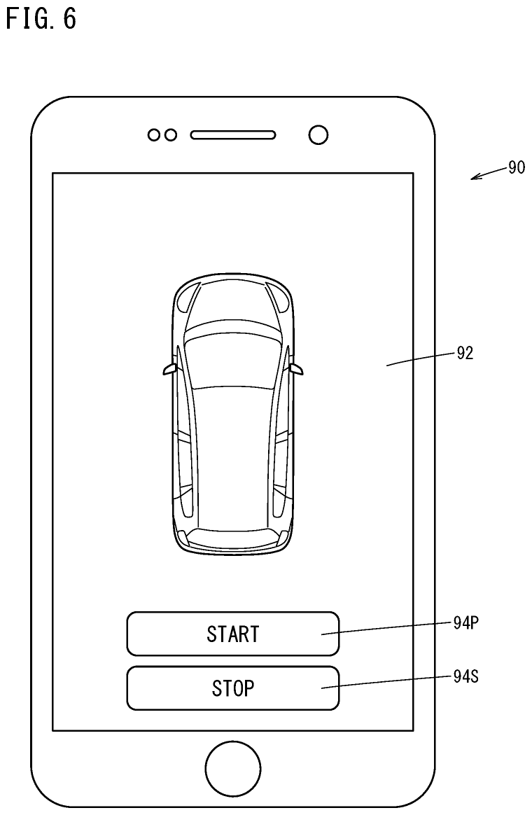

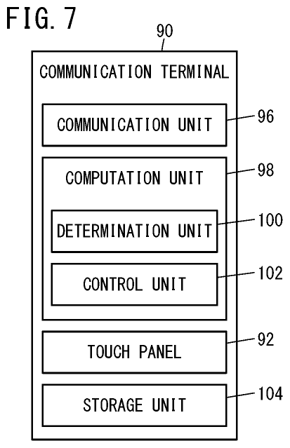

The communication unit (wireless communication unit) 22 enables wireless communications with a later-described communication terminal 90 (see FIGS. 6 and 7). The control unit 76 is capable of carrying out communications with the communication terminal 90 via the communication unit 22.

In the parking control that is performed by the parking control device 12 according to the present embodiment, there are included a target parking position setting control (target setting control), and an automated steering control. The target setting control is a control for setting the target parking position 84 for the vehicle 10. The automated steering control is a control for automatically operating the steering wheel 68 in a manner so that the vehicle 10 reaches the target parking position 84. Automated operation of the steering wheel 68 is performed by the EPS ECU 66 controlling the EPS motor 64.

The driving force control system 24 is equipped with a drive ECU 25. The driving force control system 24 executes a driving force control for the vehicle 10. The drive ECU 25 controls the driving force of the vehicle 10 by controlling a non-illustrated engine or the like on the basis of operations performed by the user on a non-illustrated accelerator pedal. The driving force control for the vehicle 10 may also be performed automatically.

The braking force control system 26 is equipped with a brake ECU 27. The braking force control system 26 executes a braking force control for the vehicle 10. The brake ECU 27 controls the braking force of the vehicle 10 by controlling a non-illustrated brake mechanism or the like on the basis of operations performed by the user on a non-illustrated brake pedal. The braking force control for the vehicle 10 may also be performed automatically.

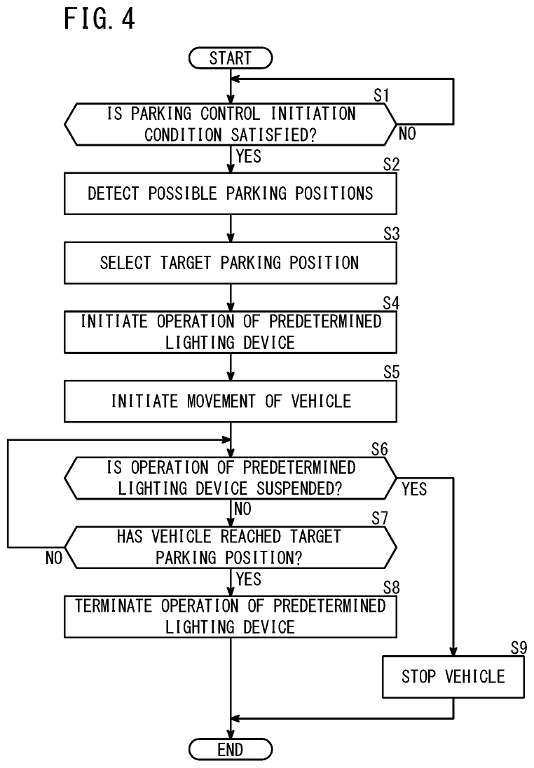

FIG. 4 is a flowchart showing operations of the parking control device according to the present embodiment. In this instance, an example will be described of a case in which, after the target parking position 84 has been selected, the control unit 76 automatically operates the emergency flashing indicator lights 23h.

In step S1, the control unit 76 determines whether or not a parking control initiation condition has been satisfied. As the parking control initiation condition, there may be cited, for example, a condition that a parking control start button (not shown) which is displayed on the touch panel 40 of the navigation device 16 has been pressed by the user. Moreover, the parking control initiation condition may be a condition that the vehicle speed V has fallen below a predetermined vehicle speed threshold. In the case that the parking control initiation condition has been satisfied (YES in step S1), the process transitions to step S2. In the case that the parking control initiation condition has not been satisfied (NO in step S1), then step S1 is executed again after the elapse of a predetermined time period.

In step S2, the detection unit 72 detects at least one possible parking position (possible parking frame) 82 in which the vehicle 10 is capable of being parked. The parking control ECU 18 carries out a control in a manner so that the detected possible parking positions 82 are displayed on the touch panel 40 of the navigation device 16. Thereafter, the process transitions to step S3.

In step S3, the target parking position 84 is selected from among the possible parking positions 82. The target parking position 84 can be selected by the user touching any one of the possible parking positions 82 displayed on the touch panel 40. Moreover, although an exemplary case has been described herein in which the target parking position 84 is selected by the user, the present invention is not limited to this feature. The target parking position 84 may be automatically selected by the control unit 76. Thereafter, the process transitions to step S4.

In step S4, the control unit 76 initiates operation of the emergency flashing indicator lights 23h.

In step S5, the control unit 76 initiates movement of the vehicle 10 into the target parking position 84. More specifically, the control unit 76 executes an automated steering control so as to automatically operate the steering wheel 68 in a manner so that the vehicle 10 reaches the target parking position 84. Operations of the accelerator pedal (not shown) and the brake pedal (not shown) are performed by the user. Moreover, in this instance, although an exemplary case has been described in which operations of driving and braking the vehicle 10 are performed by the user, the present invention is not limited to this feature. Controls for driving and braking the vehicle 10 may also be performed automatically. Automated operation of the steering wheel 68 is performed by the EPS ECU 66 controlling the EPS motor 64. Moreover, prior to initiation of movement of the vehicle 10 into the target parking position 84, a notification may be issued to a passenger concerning initiation of movement of the vehicle 10. Thereafter, the process transitions to step S6.

In step S6, the determination unit 74 determines whether or not operation of the emergency flashing indicator lights 23h has been suspended. Operation of the emergency flashing indicator lights 23h can be suspended on the basis of, for example, an operation performed by the user on the operation input unit 38. In the case that operation of the emergency flashing indicator lights 23h is suspended (YES in step S6), the process transitions to step S9. In the case that operation of the emergency flashing indicator lights 23h has not been suspended (NO in step S6), the control unit 76 continues to carry out movement of the vehicle 10 into the target parking position 84. In this case, the process transitions to step S7.

In step S7, the control unit 76 determines whether or not the vehicle 10 has reached the target parking position 84. In the case that the vehicle 10 has reached the target parking position 84 (YES in step S7), the process transitions to step S8. In the case that the vehicle 10 has not reached the target parking position 84 (NO in step S7), the process returns to step S6.

In step S8, the control unit 76 terminates operation of the emergency flashing indicator lights 23h. Thereafter, the control unit 76 terminates the parking control.

In step S9, the control unit 76 issues a notification for prompting the user to stop the vehicle 10. In accordance with such a notification, the brake pedal is operated by the user and the vehicle 10 is stopped. Upon doing so, movement of the vehicle 10 into the target parking position 84 is interrupted. Moreover, in this instance, although an exemplary case has been described in which the operation of braking the vehicle 10 is performed by the user, the present invention is not limited to this feature. The control for braking the vehicle 10 may also be performed automatically. Thereafter, the control unit 76 terminates the parking control.

In the foregoing manner, the parking control according to the present embodiment is executed.

In this manner, according to the present embodiment, after the target parking position 84 has been selected, operation of the emergency flashing indicator lights 23h is initiated, and thereafter, movement of the vehicle 10 into the target parking position 84 is initiated. Therefore, according to the present embodiment, it is possible to provide the parking control device 12 in which parking can be carried out by appropriately operating the emergency flashing indicator lights 23h.

### First Modification

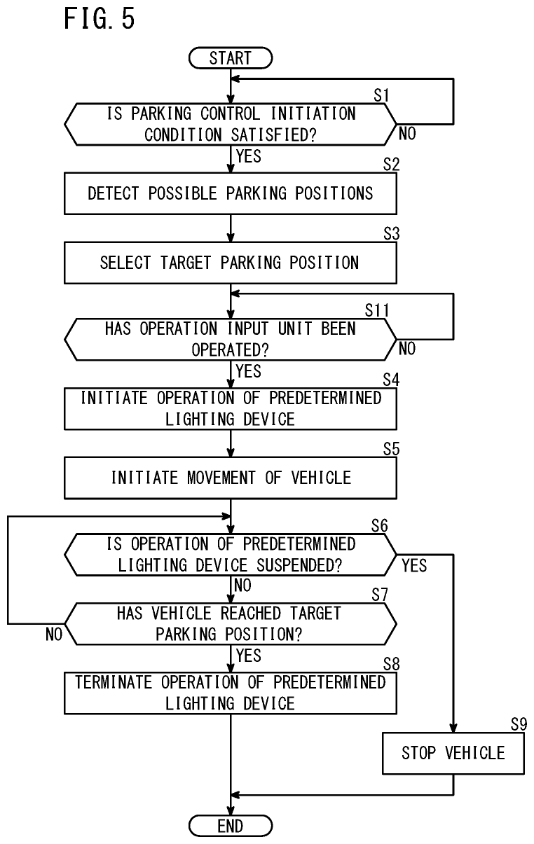

A parking control device, a parking control method, a vehicle, and a computer readable non-transitory recording medium in which a program is stored according to a first modification of the present embodiment will be described with reference to FIG. 5. FIG. 5 is a flowchart showing operations of the parking control device according to the present modification. In this instance, an example will be described of a case in which the emergency flashing indicator lights 23h are operated based on an operation performed by the user on the operation input unit 38.

First, steps S1 to S3 are the same as steps S1 to S3 described above with reference to FIG. 4, and the description thereof is therefore omitted. Thereafter, after the completion of step S3, the process transitions to step S11.

In step S11, the determination unit 74 determines whether or not the operation input unit 38 has been operated by the user. More specifically, the determination unit 74 determines whether or not the operation input unit 38 has been pressed by the user. As discussed previously, the operation input unit 38 is a switch for turning on or illuminating the emergency flashing indicator lights 23h, i.e., an emergency flashing indicator light switch. In the case that the operation input unit 38 has been pressed by the user (YES in step S11), the process transitions to step S4. In the case that the operation input unit 38 has not been pressed by the user (NO in step S11), then step S11 is executed again after the elapse of a predetermined time period.

In step S4, the control unit 76 initiates operation of the emergency flashing indicator lights 23h.

In step S5, the control unit 76 initiates movement of the vehicle 10 into the target parking position 84. In this manner, according to the present modification, the operation input unit 38 not only functions as a means for operating the emergency flashing indicator lights 23h, but also functions as a means for instructing initiation of movement of the vehicle 10 into the target parking position 84. Thereafter, the process transitions to step S6.

Steps S6 to S9 are the same as steps S6 to S9 described above with reference to FIG. 4, and the description thereof is therefore omitted.

In the foregoing manner, the parking control according to the present modification is executed.

In this manner, the emergency flashing indicator lights 23h may be operated based on an operation performed by the user on the operation input unit 38. According to the present modification, the operation input unit 38 not only functions as a means for operating the emergency flashing indicator lights 23h, but can also function as a means for instructing initiation of movement of the vehicle 10 into the target parking position 84. According to the present modification, there is no need to provide, separately from the operation input unit 38 for operating the emergency flashing indicator lights 23h, an operation input means for instructing initiation of movement of the vehicle 10 into the target parking position 84. Therefore, in accordance with the present modification, it is possible to contribute to a reduction in costs or the like.

### Second Modification

A parking control device, a parking control method, a vehicle, and a computer readable non-transitory recording medium in which a program is stored according to a second modification of the present embodiment will be described with reference to FIGS. 6 to 8. FIG. 6 is a diagram showing an example of a communication terminal used in the present modification. FIG. 7 is a block diagram showing an example of the communication terminal used in the present modification.

In the present modification, parking of the vehicle 10 can be instructed using the communication terminal 90 which is capable of communicating with the control unit 76 via the communication unit 22. According to the present modification, when the user performs an operation on a touch panel (operation input unit) 92 provided in the communication terminal 90, an instruction to park the vehicle 10 or the like is issued.

The communication terminal 90, for example, is a mobile communication terminal equipped with a telephone function. Such a communication terminal 90 is referred to as a smart phone. Moreover, the communication terminal 90 is not limited to being a smart phone. The communication terminal 90 may be a communication terminal, for example, a remote controller or the like, which is not equipped with a telephone function.

The communication terminal 90 includes a communication unit 96, a computation unit 98, the touch panel 92, and a storage unit 104. The computation unit 98 is equipped with a determination unit 100 and a control unit 102. The determination unit 100 and the control unit 102 can be realized by programs, which are stored in the storage unit 104, being executed by the computation unit 98.

On the display screen of the touch panel 92, for example, there can be displayed a button for instructing that the process of parking the vehicle 10 be initiated, and more specifically, a start button 94P. Further, on the display screen of the touch panel 92, there can be displayed a button for instructing that the process of parking the vehicle 10 be suspended, and more specifically, a stop button 94S.

The determination unit 100 determines whether or not an operation has been performed by the user on the start button 94P or the stop button 94S displayed on the display screen of the touch panel 92.

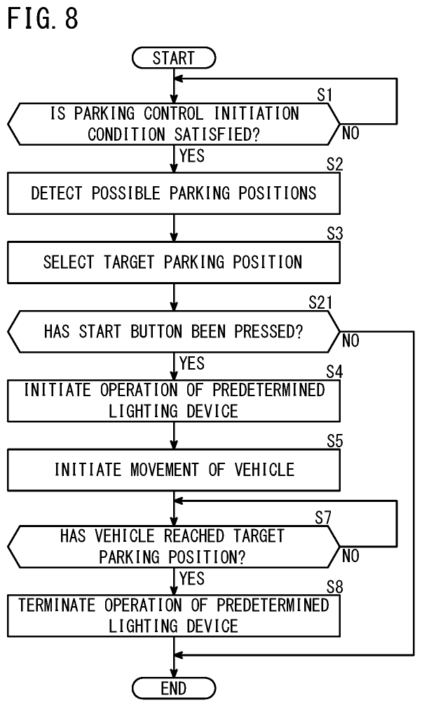

Operations of the parking control device according to the present modification will be described with reference to FIG. 8. FIG. 8 is a flowchart showing operations of the parking control device according to the present modification.

In step S1, the control unit 76 determines whether or not a parking control initiation condition has been satisfied. As the parking control initiation condition, there may be cited, for example, a condition that a parking control start button (not shown) which is displayed on the touch panel 92 has been pressed by the user. In the case that the parking control initiation condition has been satisfied (YES in step S1), the process transitions to step S2. In the case that the parking control initiation condition has not been satisfied (NO in step S1), then step S1 is executed again after the elapse of a predetermined time period.

In step S2, the detection unit 72 detects at least one possible parking position 82 in which the vehicle 10 is capable of being parked. The control unit 76 performs a control in a manner so that information indicative of the possible parking positions 82 is transmitted via the communication unit 22. At this time, the control unit 76 also transmits, via the communication unit 22, information indicative of the current position of the vehicle 10. The control unit 102 receives the information indicative of the possible parking positions 82 via the communication unit 96. At this time, the control unit 102 also receives, via the communication unit 96, the information indicative of the current position of the vehicle 10. In addition, the control unit 102 performs a control in a manner so that the information indicative of the possible parking positions 82 is displayed on the display screen of the touch panel 92. Thereafter, the process transitions to step S3.

In step S3, the target parking position 84 is selected from among the possible parking positions 82. The target parking position 84 (see FIG. 3) can be selected by the user touching any one of the possible parking positions 82 (see FIG. 3) displayed on the display screen of the touch panel 92. Moreover, although an exemplary case has been described herein in which the target parking position 84 is selected by the user, the present invention is not limited to this feature. The target parking position 84 may be automatically selected by the control unit 76 or the control unit 102. Thereafter, the process transitions to step S21.

In step S21, the determination unit 100 determines the content of the operation performed by the user on the touch panel 92. The control unit 102 transmits information indicative of the determination result by the determination unit 100 via the communication unit 96. The concerned information is supplied to the control unit 76 via the communication unit 22. In the case that the start button 94P displayed on the touch panel 92 is pressed by the user (YES in step S21), the process transitions to step S4. On the other hand, in the case that the stop button 94S displayed on the touch panel 92 is pressed by the user (NO in step S21), the control unit 76 terminates the parking control.

In step S4, the control unit 76 initiates operation of the emergency flashing indicator lights 23h.

In step S5, the control unit 76 initiates movement of the vehicle 10 into the target parking position 84. Thereafter, the process transitions to step S7.

Steps S7 and S8 are the same as steps S7 and S8 described above with reference to FIG. 4, and the description thereof is therefore omitted.

In the foregoing manner, the parking control according to the present modification is executed.

In this manner, parking of the vehicle 10 may be instructed using the communication terminal 90 which is capable of communicating with the control unit 76 via the communication unit 22. In the present modification as well, after the target parking position 84 has been selected, operation of the emergency flashing indicator lights 23h is initiated, and thereafter, movement of the vehicle 10 into the target parking position 84 is initiated. Therefore, in the present modification as well, it is possible to provide the parking control device 12 in which parking can be carried out by appropriately operating the emergency flashing indicator lights 23h.

### Modified Embodiments

Although preferred embodiments of the present invention have been described above, the present invention is not limited to the above-described embodiments, and various modifications can be made thereto without departing from the essence and gist of the present invention.

For example, in the above-described embodiments, a case has been described in which, after the target parking position 84 has been selected, movement of the vehicle 10 into the target parking position 84 is initiated on the condition that the emergency flashing indicator lights 23h are operating. However, the present invention is not limited to this feature. After the target parking position 84 has been selected, movement of the vehicle 10 into the target parking position 84 may also be initiated on the condition that the turn direction indicators 23g or the like are operating.

Summarizing the embodiments described above, the following features and advantages are realized.

The parking control device (12) includes the detection unit (72) configured to detect at least one possible parking position (82) in which the vehicle (10) is capable of being parked, and the control unit (76) configured to automatically operate the predetermined lighting device (23h) configured to be viewed from the exterior of the vehicle, after the target parking position has been selected from among the possible parking positions, and initiate movement of the vehicle into the target parking position (84) on the condition that the predetermined lighting device is operating. In accordance with such a configuration, it is possible to provide the parking control device in which parking can be carried out by appropriately operating a predetermined lighting device.

The predetermined lighting device may be the emergency flashing indicator light (23h).

The predetermined lighting device may be the turn direction indicator (23g).

The control unit may be configured to automatically operate the predetermined lighting device together with initiating movement of the vehicle into the target parking position, on the basis of an operation performed by a user on the operation input unit (38) that is used when instructing movement of the vehicle into the target parking position. In accordance with such a configuration, the user can determine the timing at which movement of the vehicle is initiated.

The operation input unit may be a switch for the user to instruct to operate the predetermined lighting device. In accordance with such a configuration, there is no need to provide, separately from the operation input unit for operating the predetermined lighting device, an operation input means for instructing initiation of movement of the vehicle into the target parking position. Therefore, in accordance with such a configuration, it is possible to contribute to a reduction in costs or the like.

Before movement of the vehicle into the target parking position is initiated, the control unit may be configured to issue a notification to a passenger concerning initiation of movement of the vehicle. In accordance with such a configuration, it is possible to prevent the passenger from experiencing a sense of discomfort.

When movement of the vehicle into the target parking position is completed, the control unit may be configured to automatically terminate operation of the predetermined lighting device. In accordance with such a configuration, it is acceptable for the user not to perform any operations for terminating operation of the predetermined lighting device.

In the case that operation of the predetermined lighting device is suspended during movement of the vehicle into the target parking position, movement of the vehicle into the target parking position may be interrupted. In accordance with such a configuration, it is possible to prevent the vehicle from moving in a state in which the predetermined lighting device is not operating.

The vehicle includes the above-described parking control device.

The parking control method comprises a step (step S2) of detecting at least one possible parking position in which the vehicle is capable of being parked, and a step (steps S3 to S5) of automatically operating the predetermined lighting device configured to be viewed from the exterior of the vehicle, after the target parking position has been selected from among the possible parking positions, and initiating movement of the vehicle into the target parking position on the condition that the predetermined lighting device is operating.

In the computer readable non-transitory recording medium, a program is stored for executing in a computer a step of detecting at least one possible parking position in which the vehicle is capable of being parked, and a step of automatically operating the predetermined lighting device configured to be viewed from the exterior of the vehicle, after the target parking position has been selected from among the possible parking positions, and initiating movement of the vehicle into the target parking position on the condition that the predetermined lighting device is operating.

What is claimed is:

1. A parking control device, comprising:
a detection unit configured to detect at least one possible parking position in which a vehicle is capable of being parked; and
a control unit configured to automatically operate a predetermined lighting device configured to be viewed from an exterior of the vehicle, after a target parking position has been selected from among the possible parking positions, and initiate movement of the vehicle into the target parking position on condition that the predetermined lighting device is operating.

2. The parking control device according to claim 1, wherein the predetermined lighting device is an emergency flashing indicator light.

3. The parking control device according to claim 1, wherein the predetermined lighting device is a turn direction indicator.

4. The parking control device according to claim 1, wherein the control unit is configured to automatically operate the predetermined lighting device together with initiating movement of the vehicle into the target parking position, on a basis of an operation performed by a user on an operation input unit that is used when instructing movement of the vehicle into the target parking position.

5. The parking control device according to claim 4, wherein the operation input unit is a switch for the user to instruct to operate the predetermined lighting device.

6. The parking control device according to claim 1, wherein, before movement of the vehicle into the target parking position is initiated, the control unit is configured to issue a notification to a passenger concerning initiation of movement of the vehicle.

7. The parking control device according to claim 1, wherein, when movement of the vehicle into the target parking position is completed, the control unit is configured to automatically terminate operation of the predetermined lighting device.

8. The parking control device according to claim 1, wherein, in a case that operation of the predetermined lighting device is suspended during movement of the vehicle into the target parking position, movement of the vehicle into the target parking position is interrupted.

9. A vehicle comprising the parking control device according to claim 1.

10. A parking control method, comprising:
a step of detecting at least one possible parking position in which a vehicle is capable of being parked; and
a step of automatically operating a predetermined lighting device configured to be viewed from an exterior of the vehicle, after a target parking position has been selected from among the possible parking positions, and initiating movement of the vehicle into the target parking position on condition that the predetermined lighting device is operating.

11. A computer readable non-transitory recording medium in which a program is stored for executing in a computer:
a step of detecting at least one possible parking position in which a vehicle is capable of being parked; and
a step of automatically operating a predetermined lighting device configured to be viewed from an exterior of the vehicle, after a target parking position has been selected from among the possible parking positions, and initiating movement of the vehicle into the target parking position on condition that the predetermined lighting device is operating.
